(19) United States
(12) Patent Application Publication
(10) Pub. No.: US 2024/0326261 A1
(43) Pub. Date: Oct. 3, 2024

(54) End Effectors for Robotic Units Used to Open and Close Vehicle Doors

(71) Applicant: Nissan North America, Inc., Franklin, TN (US)

(72) Inventors: Mario Guadulupe Bocanegra, III, Murfreesboro, TN (US); Andrew Williamson, Smyrna, TN (US); Aaron Butler, Lebanon, TN (US); Glen Dodson, Murfreesboro, TN (US)

(21) Appl. No.: 18/194,922

(22) Filed: Apr. 3, 2023

(51) Int. Cl. B25J 15/00; B25J 9/16

(52) U.S. Cl. CPC B25J 15/0047; B25J 9/1694; B25J 11/0075

(57) ABSTRACT

An end effector for a robotic unit used to manipulate a vehicle door, which includes: a detection module; a transmission member extending into the detection module and configured to generate a detection signal; a toggle configured for engagement with the vehicle door via movement of the end effector along a first (e.g., (generally) vertical) axis; and an interrupter operatively connected to the toggle such that engagement of the toggle with the vehicle door and disengagement of the toggle from the vehicle door displaces the interrupter along a second (e.g., (generally) horizontal) axis between a first position, in which the interrupter interferes with the detection signal to thereby inhibit circuit completion, and a second position, in which the interrupter permits transmission of the detection signal across the detection module to thereby permit circuit completion and inform the robotic unit of engagement between the end effector and the vehicle door.

### TECHNICAL FIELD

The present disclosure relates to vehicle manufacture and, more specifically, to end effectors for robotic units used to manipulate (e.g., open and close) vehicle doors during manufacture (e.g., painting).

### BACKGROUND

Many vehicle manufacturers employ robotic units during vehicle painting to not only open and close the vehicle doors, but to apply paint to the vehicle doors. Typically, one robotic unit is used to open and close the vehicle doors, and another robotic unit is used for paint application. Usually, opening and closure of the vehicle doors is accomplished by inserting a tool (e.g., a pin, a paddle, a gripper, etc.) into the window channels in the vehicle doors or via magnetic engagement between the tool and the vehicle doors. Before a vehicle door is opened, however, the robotic units typically require confirmation that the vehicle door is not only present, but sufficiently engaged by the robotic unit, absent which, movement and operation of the robotic unit will not occur or will cease.

The tools associated with known robotic units have several drawbacks. For example, known tools are often large, which creates an obstacle that may impede paint application as well as difficulties regarding insertion, removal, and operation, particularly in the context of smaller vehicles and/or vehicles with curved windows. Known tools also often present programming challenges resulting from issues concerning detection of the vehicle doors and confirmation of positive engagement therewith, and create a potential for loss of detection and/or engagement (e.g., due to sudden conveyor stops that may release the necessary tension on the robotic unit required to maintain detection and/or engagement). Additionally, known magnetic tools are largely incompatible with vehicle doors that include non-magnetic materials of construction (e.g., aluminum).

The present disclosure addresses these shortcomings by providing improved end effectors for robotic units for use in manipulating a vehicle door during manufacture (e.g., painting).

### SUMMARY

In one aspect of the present disclosure, an end effector is disclosed for a robotic unit that is used to manipulate a vehicle door during manufacture (e.g., painting). The end effector includes: a mounting bracket that is configured for connection to the robotic unit; a main housing that extends from the mounting bracket and which defines a longitudinal axis of the end effector; a detection module that is secured to the main housing; a transmission member that extends into the detection module and which is configured to generate a detection signal; a dowel that is operatively connected to the main housing and which is configured for insertion into the vehicle door; a toggle that is pivotably connected to the dowel and which is configured for engagement with the vehicle door such that the toggle is repositioned from a normal position to a deflected position upon engagement with the vehicle door and such that the toggle is repositioned from the deflected position to the normal position upon disengagement from the vehicle door; and an interrupter that is operatively connected to the toggle such that movement of the toggle from the normal position into the deflected position causes corresponding movement of the interrupter in generally parallel relation to the longitudinal axis of the end effector from a blocking position, in which the interrupter interferes with the detection signal to thereby inhibit circuit completion, into a transmission position, in which the interrupter permits transmission of the detection signal across the detection module to thereby permit circuit completion and inform the robotic unit of engagement between the end effector and the vehicle door, and such that movement of the toggle from the deflected position into the normal position causes corresponding movement of the interrupter from the transmission position into the blocking position.

In certain embodiments, the end effector may further include one or more biasing members that are positioned between the toggle and the dowel to bias the toggle towards the normal position.

In certain embodiments, the end effector may further include a clevis that is pivotably connected to the toggle such that movement of the toggle between the normal position and the deflected position causes corresponding movement of the clevis.

In certain embodiments, the end effector may further include a dowel cap that is connected to the main housing.

In certain embodiments, the dowel may be connected to the dowel cap such that the dowel extends from the dowel cap in generally orthogonal relation to the longitudinal axis of the end effector.

In certain embodiments, the dowel cap may define an internal cavity that is configured to receive the clevis, whereby the dowel cap protects the clevis from paint overspray during manufacture of the vehicle door.

In certain embodiments, the end effector may further include a drive shaft that is connected to the clevis such that movement of the clevis causes corresponding movement of the drive shaft.

In certain embodiments, the end effector may further include one or more guide bearings that are received by the main housing.

In certain embodiments, the one or more guide bearings may be configured to receive the drive shaft such that the drive shaft extends into the one or more guide bearings, whereby the one or more guide bearings inhibit off-axis movement of the drive shaft.

In certain embodiments, the interrupter may be operatively connected to the drive shaft such that movement of the drive shaft causes corresponding movement of the interrupter between the blocking position and the transmission position.

In certain embodiments, the end effector may further include a coupling that is located within the main housing.

In certain embodiments, the drive shaft may extend through the coupling.

In certain embodiments, the coupling may be directly connected to the drive shaft.

In certain embodiments, the interrupter may be directly connected to the coupling such that movement of the drive shaft causes corresponding movement of the coupling and the interrupter.

In another aspect of the present disclosure, an end effector is disclosed for a robotic unit that is used to manipulate a vehicle door during manufacture (e.g., painting). The end effector includes: a detection module; a transmission member that extends into the detection module and which is configured to generate a detection signal such that the detection signal is transmitted across the detection module; a toggle that is configured for engagement with the vehicle door via movement of the end effector along a first axis; and an interrupter that is operatively connected to the toggle such that engagement of the toggle with the vehicle door and disengagement of the toggle from the vehicle door causes movement of the interrupter along a second axis, which extends in generally orthogonal relation to the first axis, between a first position, in which the interrupter interferes with the detection signal to thereby inhibit circuit completion, and a second position, in which the interrupter permits transmission of the detection signal across the detection module to thereby permit circuit completion and inform the robotic unit of engagement between the end effector and the vehicle door.

In certain embodiments, the detection module may include a detection module housing that is configured to receive the transmission member and a detection module cover that is connected to the detection module housing.

In certain embodiments, the detection module cover may define a first axial channel that is configured to receive the interrupter such that the interrupter is movable through the first axial channel during movement between the first position and the second position.

In certain embodiments, the detection module housing may define: a first groove that is configured to receive a feed section of the transmission member; a second groove that is configured to receive a return section of the transmission member; and a second axial channel that extends between the first groove and the second groove.

In certain embodiments, the first groove and the second groove may be configured such that the feed section of the transmission member and the return section of the transmission member are in communication with each other, whereby the detection signal is transmitted across the detection module.

In certain embodiments, the second axial channel may be configured to receive the interrupter such that the interrupter is movable through the second axial channel during repositioning of the interrupter between the first position and the second position.

In certain embodiments, the first groove and the second groove may each define an ingress and an egress.

In certain embodiments, the first groove and the second groove may be non-linear in configuration such that the egresses defined by the first groove and the second groove are oriented in facing relation.

In certain embodiments, the interrupter may include a body portion and a flag that extends from the body portion in generally orthogonal relation thereto.

In certain embodiments, the flag may extend in generally orthogonal relation to the second axis.

In another aspect of the present disclosure, a method of detecting engagement between a robotic unit and a vehicle door during manufacture (e.g., painting) is disclosed. The method includes inserting an end effector on the robotic unit into a window channel of the vehicle door along a first axis and displacing a toggle on the end effector via engagement with the vehicle door to cause corresponding displacement of an interrupter operatively connected to the toggle along a second axis that is oriented in generally orthogonal relation to the first axis, wherein displacement of the interrupter permits completion of a circuit so as to inform the robotic unit of engagement between the end effector and the vehicle door.

In certain embodiments, displacing the toggle may include repositioning a drive shaft that is operatively connected to the toggle.

In certain embodiments, the interrupter may be operatively connected to the drive shaft.

In certain embodiments, displacing the toggle may include compressing one or more biasing members that are in engagement with the toggle.

In certain embodiments, displacing the toggle may include pivoting the toggle in relation to a dowel that is configured for insertion into the window channel.

In certain embodiments, the one or more biasing members may be positioned between the toggle and the dowel.

### BRIEF DESCRIPTION OF THE DRAWINGS

According to common practice, the various features of the drawings may not be to scale and may be arbitrarily expanded or reduced for clarity.

FIG. 1 is a side, plan view of a robotic unit and an end effector for use therewith to manipulate (e.g., open and close) a vehicle door during manufacture (e.g., painting).

FIG. 2 is a top, perspective view of the end effector shown separated from the robotic unit.

FIG. 3 is a cross-sectional view of the end effector shown prior to engagement with the vehicle door.

FIG. 4 is a cross-sectional view of the end effector shown upon engagement with the vehicle door.

FIG. 5 is a top, perspective view of a mounting bracket of the end effector.

FIG. 6 is a partial, top, perspective view of the end effector.

FIG. 7 is a top, perspective view of the end effector shown with parts separated.

FIG. 8 is a bottom, perspective view of the end effector shown with parts separated.

FIG. 9 is a partial, top, perspective view of the end effector shown with parts separated.

FIG. 10 is a partial, bottom, perspective view of the end effector.

FIG. 11 is a partial, bottom, perspective view of the end effector.

FIG. 12 is a partial, bottom, perspective view of a detection module of the end effector.

FIG. 13 is a partial, cross-sectional view of the detection module shown prior to engagement of the end effector with the vehicle door.

FIG. 14 is a partial, cross-sectional view of the detection module shown upon engagement of the end effector with the vehicle door.

### DETAILED DESCRIPTION

The present disclosure describes an end effector that is configured for use with a robotic unit in order to manipulate (e.g., open and close) a vehicle door during manufacture (e.g., during painting of the vehicle door and/or the vehicle). The end effector includes a toggle that is configured for engagement with and disengagement from the vehicle door via movement of the end effector along a (generally) vertical axis, and an interrupter that is operatively (e.g., indirectly) connected (secured) to the toggle such that engagement of the toggle with, and disengagement of the toggle from, the vehicle door causes movement of the interrupter along a (generally) horizontal axis between first and second positions. In the first position, the interrupter interferes with a (fiber optic) detection signal that is transmitted within the end effector so as to inhibit (if not entirely prevent) the completion of a circuit, whereas in the second position, the interrupter permits transmission of the detection signal across the end effector so as to allow for completion of the circuit and thereby inform the robotic unit of engagement between the end effector and the vehicle door.

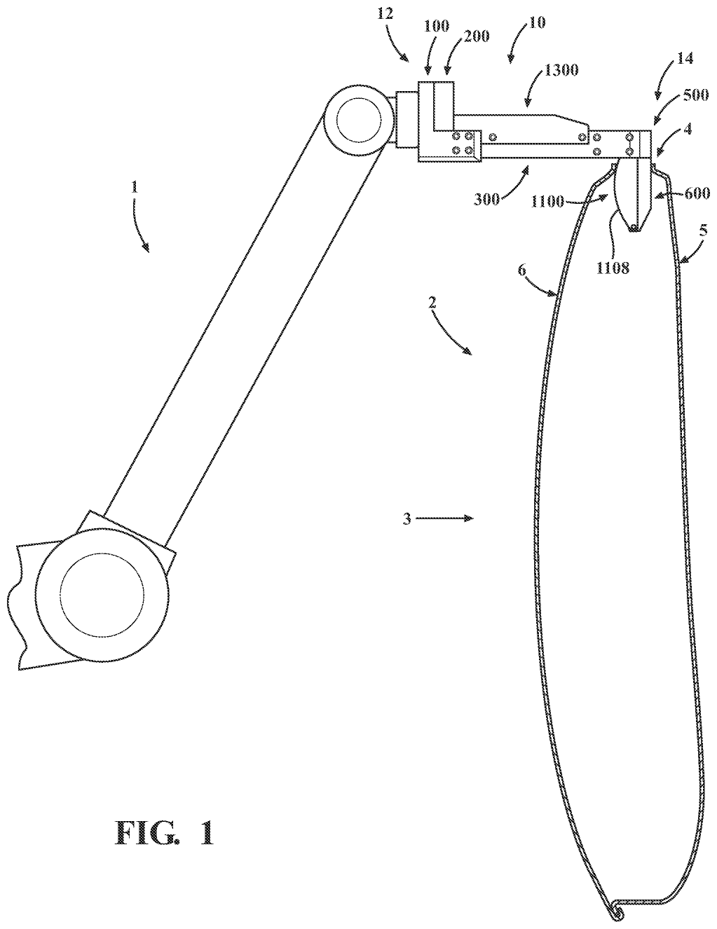

With reference to FIG. 1, a robotic unit 1 is illustrated for use during the painting of a vehicle 2 (e.g., one or more vehicle doors 3 on the vehicle 2). The robotic unit 1 includes an end effector 10, which is the subject of the present disclosure, that is configured to individually engage and manipulate (e.g., open and close) the vehicle doors 3. More specifically, as described in further detail below, the end effector 10 is configured for engagement (contact) with a window channel 4 in each vehicle door 3, which is defined by, and extends between, respective inner and outer panels (surfaces) 5, 6 thereof. So as not to interfere with the application of paint to the vehicle 2, it is envisioned that certain components of the end effector 10 (e.g., various external components thereof) may include (e.g., may be formed partially or entirely from) one or more non-electrostatic materials, whereas other components of the end effector 10 (e.g., various internal components thereof) may include (e.g., may be formed partially or entirely from) one or more metallic materials (e.g., aluminum, steel, etc.).

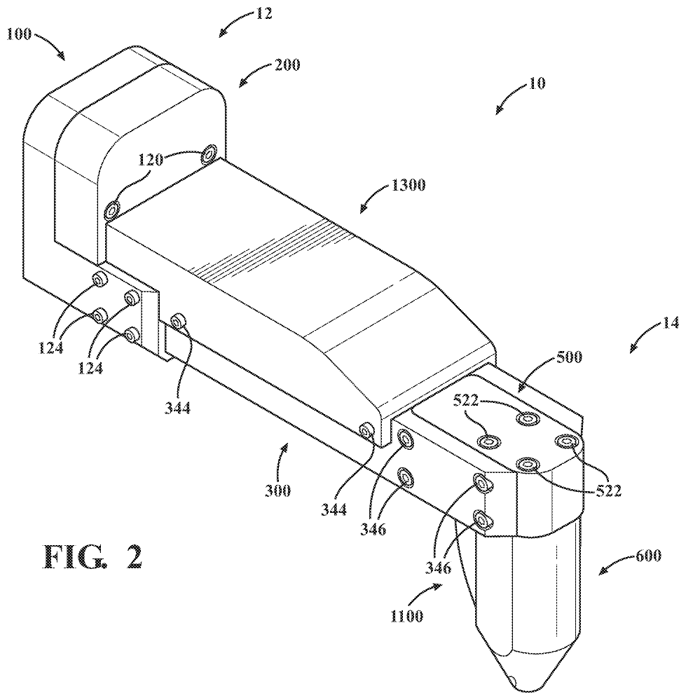

Referring to FIGS. 2-14 as well, the end effector 10 is configured for releasable connection to the robotic unit 1 (FIG. 1) and provides for increased vertical spacing between the surfaces on the vehicle door 3 contacted by the end effector 10 (e.g., the outer panel 6

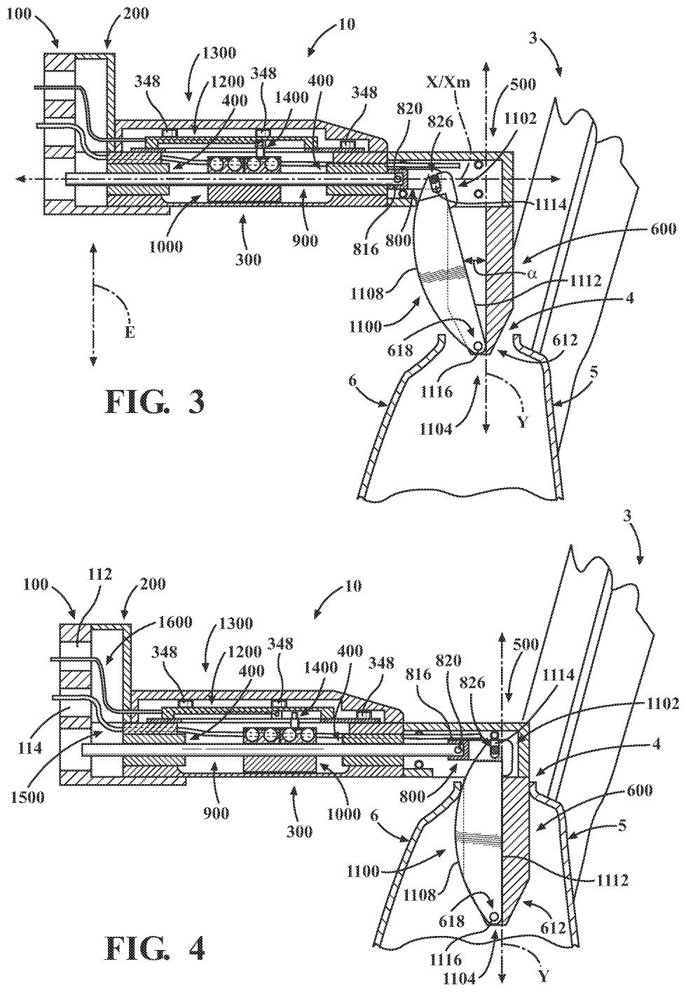

adjacent to the window channel 4) and the robotic unit 1. As described in further detail below, the end effector 10 is resiliently reconfigurable between a passive (first) configuration (e.g., prior to engagement (contact) with the vehicle door 3), which is shown in FIGS. 2 and 3, and an active (second) configuration (e.g., upon engagement (contact) with the vehicle door 3), which is shown in FIGS. 1 and 4.

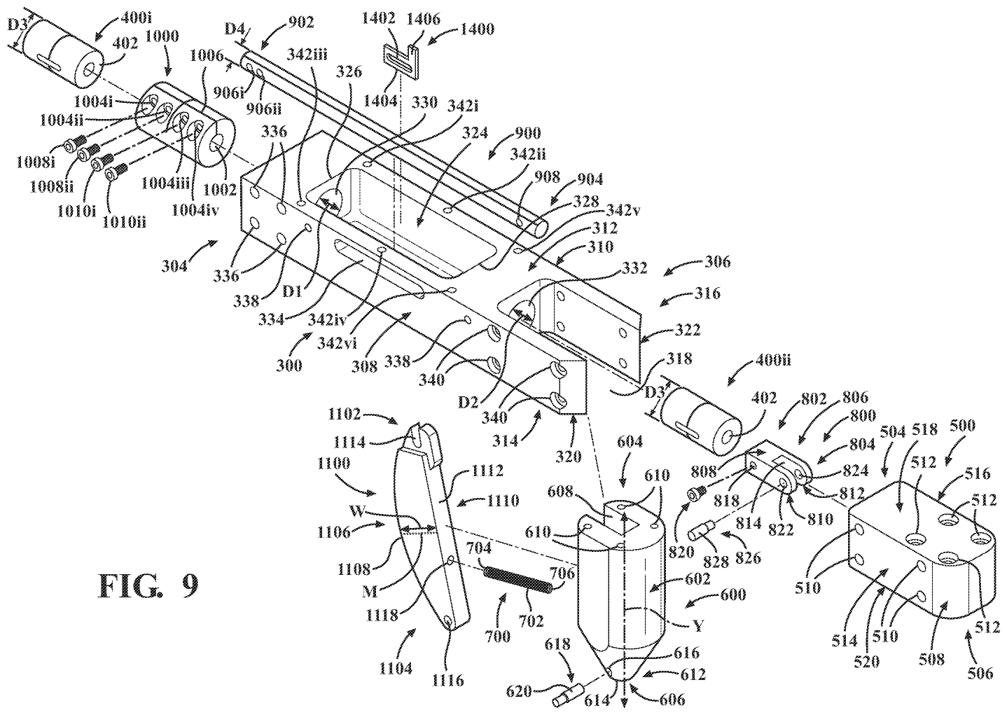

The end effector 10 defines a proximal end 12, which is configured for releasable connection to the robotic unit 1, and a distal (operative) end 14, and includes: a mounting bracket 100; a bracket cover 200; a main housing 300; one or more guide bearings 400; a dowel cap 500; a dowel 600; one or more biasing members 700 (FIG. 9) (e.g., one or more springs 702); a clevis 800; a drive shaft 900; a coupling 1000; a toggle 1100; a detection module 1200; a top cover 1300; and an interrupter 1400. Throughout the following discussion, the term “proximal” should be understood as referring to that end, portion, or section of a component that is closest to the robotic unit 1 (FIG. 1), whereas the term “distal” should be understood as referring to that end, portion, or section of a component that is furthest from the robotic unit 1.

The mounting bracket 100 (FIGS. 1-5) is configured for connection to the robotic unit 1 and facilitates (supports) pneumatic as well as fiber optic and/or electrical connectivity between the end effector 10 and the robotic unit 1. In the illustrated embodiment, the mounting bracket 100 includes (e.g., is formed partially or entirely from) a non-metallic material (e.g., nylon). It should be appreciated, however, that the mounting bracket 100 may include any suitable material (or combination of materials), and that the mounting bracket 100 may be formed through any suitable method of manufacture (e.g., 3-D printing, machining, casting, etc.).

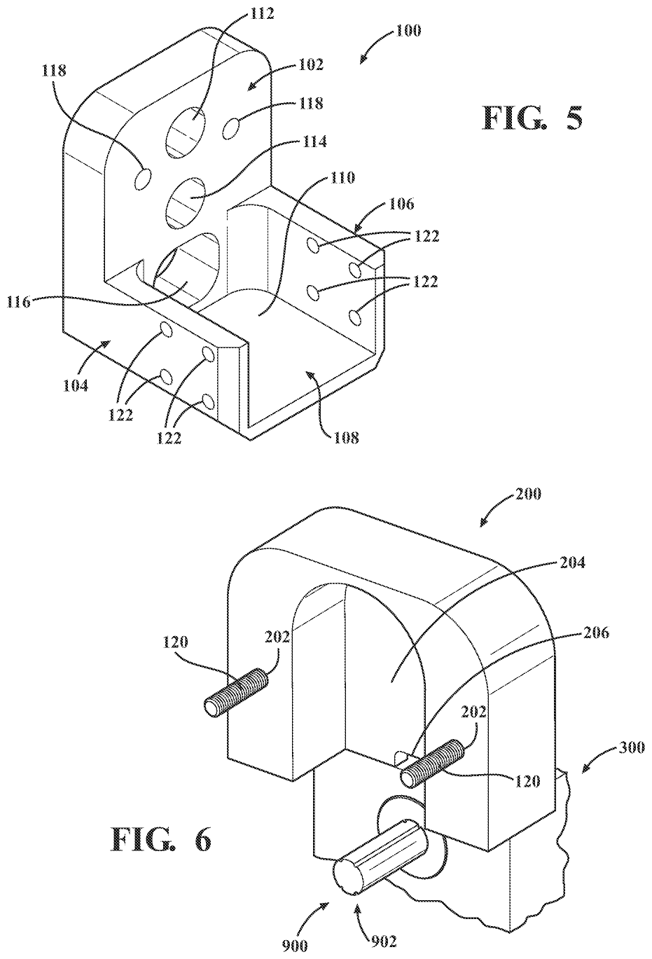

The mounting bracket 100 is generally L-shaped in configuration and includes a proximal end wall 102 as well as a pair of sidewalls 104, 106 and a base wall that each extend distally from the end wall 102. The end wall 102, the sidewalls 104, 106, and the base wall 108 collectively define a chamber 110 (FIG. 5) that is configured to receive the main housing 300 such that the main housing 300 extends into (and distally from) the mounting bracket 100.

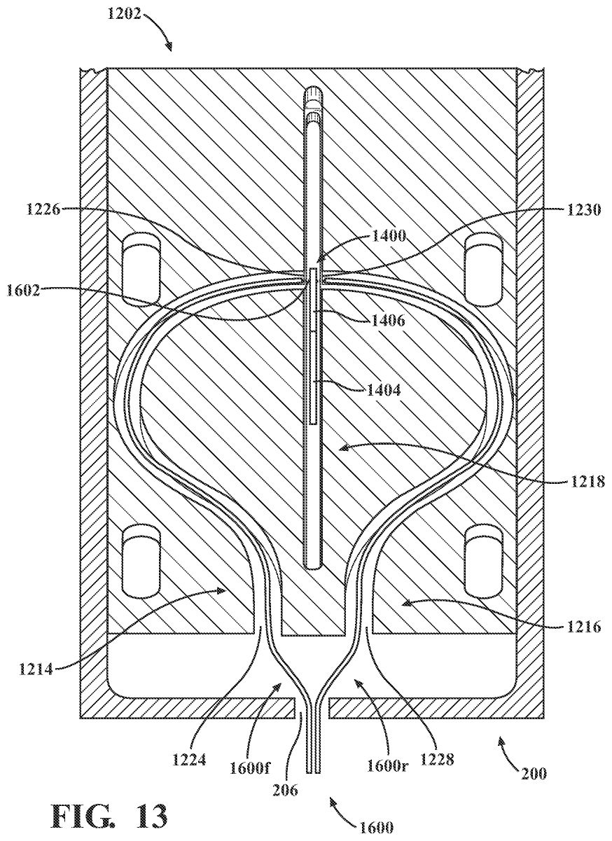

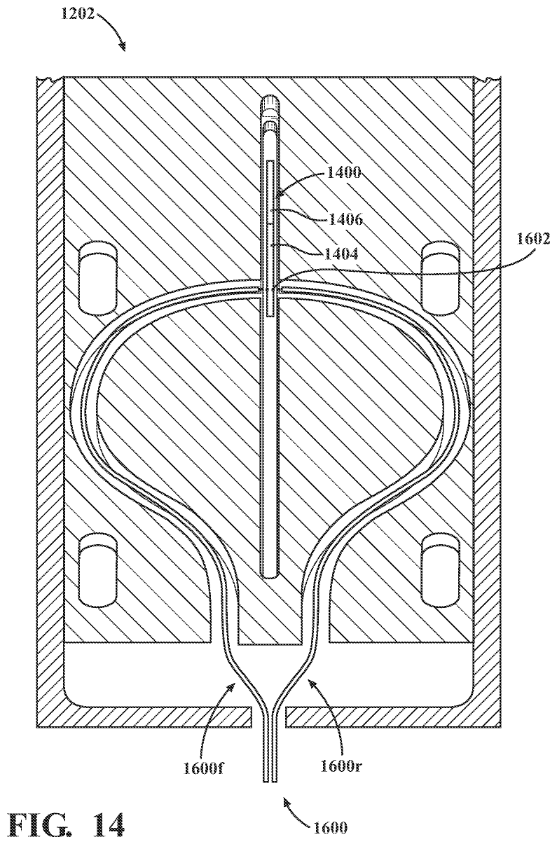

The end wall 102 includes respective upper and lower (first and second) openings 112, 114 that extend therethrough. The upper opening 112 is configured to receive an airline 1500, which facilitates internal pressurization of the end effector 10 in order to maintain cleanliness, remove debris, and inhibit (if not entirely prevent) paint overspray during manufacturing (e.g., painting) of the vehicle door 3, and a transmission member 1600 (e.g., one or more fiber optic and/or electrical cables), which is configured to generate a detection signal 1602 (FIGS. 13, 14) (e.g., a fiber optic beam) that is utilized to inform the robotic unit 1 of engagement (contact) between the end effector 10 and the vehicle door 3, as described in further detail below. Additionally, the end wall 102 includes a window 116 that is configured to receive the drive shaft 900 (FIGS. 3, 4), which facilitates axial (linear) movement (displacement) of the drive shaft 900 along a ((generally) horizontal) axis of movement Xm (FIGS. 3, 4) during reconfiguration of the end effector 10 between the passive and active configurations, as described in further detail below, as well as one or more apertures 118 that are configured to receive corresponding mechanical fasteners 120 (FIGS. 2, 6) (e.g., screws, pins, clips, etc.) so as to facilitate connection of the bracket cover 200 to the mounting bracket 100.

Upon assembly of the end effector 10, the sidewalls 104, 106 and the base wall 108 extend about the main housing 300 such that the main housing 300 is received and supported by the mounting bracket 100. As seen in FIG. 5, the sidewalls 104, 106 include apertures 122 that are configured to receive corresponding mechanical fasteners 124 (FIG. 2) (e.g., screws, pins, clips, etc.) so as to facilitate connection of the main housing 300 to the mounting bracket 100.

The bracket cover 200 (FIGS. 1-4, 6) conceals and protects the airline 1500 (FIGS. 3, 4) and the transmission member 1600, and is positioned distally of the mounting bracket 100. More specifically, the bracket cover 200 is positioned adjacent to (e.g., in contacting relation with), and is supported by, the proximal end wall 102 (FIG. 5) and the sidewalls 104, 106 of the mounting bracket 100. The bracket cover 200 is configured for connection to the mounting bracket 100 via the mechanical fasteners 120, which extend into and through corresponding apertures 202 formed in the bracket cover 200. In the illustrated embodiment, the bracket cover 200 includes (e.g., is formed partially or entirely from) a non-metallic material (e.g., nylon). It should be appreciated, however, that the bracket cover 200 may include any suitable material (or combination of materials), and that the bracket cover 200 may be formed through any suitable method of manufacture (e.g., 3-D printing, machining, casting, etc.).

As seen in FIG. 6, the bracket cover 200 defines a cavity 204, which extends distally into the bracket cover 200 so as to create space for the airline 1500 and the transmission member 1600 that facilitates routing of the airline 1500 and the transmission member 1600 from the robotic unit 1 into the end effector 10, as well as a recess 206, which is configured to receive the transmission member 1600 such that the transmission member 1600 extends through the bracket cover 200 and into the detection module 1200, as described in further detail below.

The main housing 300 (FIGS. 1-4 and 7-9) defines (and extends along) a longitudinal axis X of the end effector 10 and provides a chassis 302 that supports the various components thereof. In the illustrated embodiment, the main housing 300 includes (e.g., is formed partially or entirely from) a non-metallic material (e.g., nylon). It should be appreciated, however, that the main housing 300 may include any suitable material (or combination of materials), and that the main housing 300 may be formed through any suitable method of manufacture (e.g., 3-D printing, machining, casting, etc.).

The main housing 300 defines a proximal (first) end 304, which is received by the chamber 110 defined by the mounting bracket 100, and a distal (second) end 306, and includes a pair of sidewalls 308, 310 and an upper wall 312.

As seen in FIG. 9, the distal end 306 of the main housing 300 includes a forked configuration. More specifically, the distal end 306 of the main housing 300 includes (defines) a pair of legs 314, 316 that define a receiving space 318 therebetween. The receiving space 318 is configured to receive the dowel cap 500 such that the dowel cap 500 extends into, and is supported by, the main housing 300.

In the illustrated embodiment, the legs 314, 316 include chamfered (angled, beveled) tips 320, 322, respectively, that taper inwardly as distance from the proximal end 304 of the main housing 300 increases. The chamfered configuration of the tips 320, 322 reduces and smooths the outer contour (profile) of the end effector 10 at the distal end 14 thereof, thereby reducing (if not entirely eliminating) the presence of hard corners.

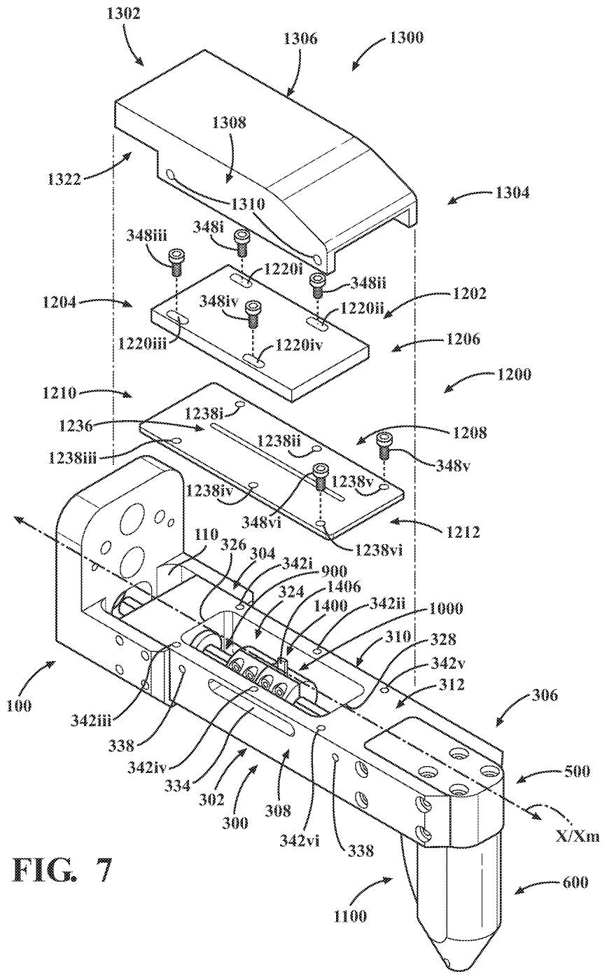

As seen in FIGS. 7 and 9, the main housing 300 includes (defines) an internal compartment 324 having respective proximal and distal ends 326, 328, as well as a pair of (e.g., proximal and distal) receptacles 330, 332.

The internal compartment 324 is configured to receive the drive shaft 900 as well as the coupling 1000 and the interrupter 1400, which allows for axial (linear) movement (displacement) of the drive shaft 900, the coupling 1000, and the interrupter 1400 (e.g., within the main housing 300) along the axis of movement Xm, which extends in (generally) parallel relation to the longitudinal axis X of the end effector 10, during reconfiguration of the end effector 10 between the passive configuration (FIGS. 2, 3) and the active configuration (FIGS. 1, 4). In order to facilitate access to the internal compartment 324, the main housing 300 includes a window 334, which extends through the sidewall 308 in (generally) parallel relation to the longitudinal axis X of the end effector 10. The window 334 is in communication with the internal compartment 324 and, thus, facilitates access to the drive shaft 900, the coupling 1000, the interrupter 1400, etc. (e.g., during assembly, disassembly, and/or maintenance of the end effector 10).

The receptacles 330, 332 extend in (generally) parallel relation to the longitudinal axis X and are configured to receive the guide bearing(s) 400 and the drive shaft 900. The receptacles 330, 332 are in communication with the internal compartment 324 and extend from the respective proximal and distal ends 326, 328 thereof. More specifically, the receptacle 330 extends from the proximal end 326 of the internal compartment 324 in a proximal direction (e.g., towards the robotic unit 1 (FIG. 1)), and the receptacle 332 extends from the distal end 328 of the internal compartment 324 in the distal direction (e.g., away from the robotic unit 1).

In the illustrated embodiment, the receptacles 330, 332 are (generally) identical in configuration and define (generally) equivalent inner transverse cross-sectional dimensions (e.g., diameters) D1, D2, which allows for the receipt of corresponding (proximal, first and distal, second) guide bearings 400i, 400ii. Embodiments of the main housing 300 in which the configurations of the receptacles 330, 332 may be non-identical, however, are also envisioned herein (e.g., embodiments in which the inner transverse cross-sectional dimensions D1, D2 may be non-equivalent), as described in further detail below.

In order to facilitate connection of the main housing 300 to the mounting bracket 100, the top cover 1300, the dowel cap 500, and the detection module 1200, the main housing 300 includes respective apertures 336, 338, 340, 342, which extend into the sidewalls 308, 310 and the upper wall 312 thereof. More specifically, the apertures 336 extend into the sidewalls 308, 310 at the proximal end 304 of the main housing 300 and are configured to receive the mechanical fasteners 124 (FIG. 2), which extend through the mounting bracket 100 and into the main housing 300, the apertures 338 extend into the sidewalls 308, 310 distally of the apertures 336 and are configured to receive corresponding mechanical fasteners 344 (FIG. 2) (e.g., screws, pins, clips, etc.), which extend through the top cover 1300 and into the main housing 300, the apertures 340 extend into the sidewalls 308, 310 at the distal end 306 of the main housing 300 and are configured to receive corresponding mechanical fasteners 346 (FIG. 2) (e.g., screws, pins, clips, etc.), which extend through the main housing 300 and into the dowel cap 500, and the apertures 342 extend into the upper wall 312 and are configured to receive corresponding mechanical fasteners 348 (FIGS. 3, 4, 7) (e.g., screws, pins, clips, etc.), which extend through the detection module 1200 and into the main housing 300.

The guide bearing(s) 400 (FIGS. 3, 4, and 9) include (e.g., are formed partially or entirely from) a metallic material (e.g., stainless steel) and are configured for insertion into the receptacles 330, 332 in an interference (press) fit. More specifically, each guide bearing 400 defines outer transverse cross-sectional dimension (e.g., a diameter) D3 that (substantially) approximates the inner transverse cross-sectional dimensions D1, D2 defined by the receptacles 330, 332.

Each guide bearing 400 includes (defines) an axial passage 402 that is configured to receive the drive shaft 900 such that the drive shaft 900 extends into (and through) the guide bearings 400, whereby the guide bearings 400 inhibit (if not entirely prevent) off-axis movement (displacement) of the drive shaft 900 (e.g., rattling or other such lateral deflection). The guide bearings 400 are thus configured to (generally) restrict the drive shaft 900 to linear motion (e.g., movement (displacement) along the axis of movement Xm) during reconfiguration of the end effector 10 between the passive and active configurations.

While the end effector 10 includes a pair of guide bearings 400i, 400ii in the illustrated embodiment, embodiments of the end effector 10 including a single guide bearing 400 are also envisioned herein and would not be beyond the scope of the present disclosure. In such embodiments, it is envisioned that the (single) guide bearing 400 may be located (positioned) within one of the receptacles 330, 332 and that the other of the receptacles 330, 332 may be configured to receive and support the drive shaft 900. For example, it is envisioned that the guide bearing 400 may be inserted into the receptacle 330 and that the receptacle 332 may be configured to receive the drive shaft 900, or that the guide bearing 400 may be inserted into the receptacle 332 and that the receptacle 330 may be configured to receive the drive shaft 900. In such embodiments, in order to further support axial (linear) movement (displacement) of the drive shaft 900, it is envisioned that the inner transverse cross-sectional dimension D2 (or the inner transverse cross-sectional dimension D1) may be reduced to (substantially) approximate an outer transverse cross-sectional dimension (e.g., a diameter) D4 defined by the drive shaft 900.

In the illustrated embodiment, the receptacles 330, 332 are configured to receive the guide bearings 400i, 400ii such that the guide bearings 400i, 400ii are (generally) flush with the respective proximal and distal ends 326, 328 of the internal compartment 324. Embodiments in which the guide bearing 400i and/or the guide bearing 400ii may extend into the internal compartment 324, however, are also envisioned herein and would not be beyond the scope of the present disclosure.

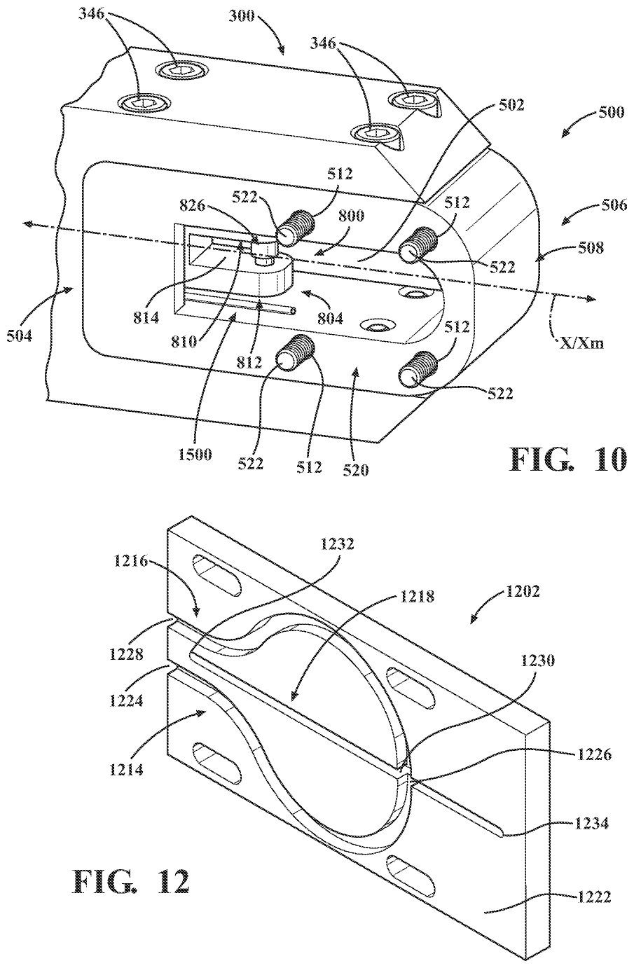

The dowel cap 500 (FIGS. 1-4, 7, 9, and 10) is connected (secured) to the main housing 300 and is positioned between the legs 314, 316 (FIG. 9) thereof such that the dowel cap 500 is located within the receiving space 318, as indicated above. The dowel cap 500 supports the dowel 600 and receives the clevis 800, the drive shaft 900, and the toggle 1100 (e.g., in order to protect the clevis 800, the drive shaft 900, and the toggle 1100 from paint overspray). More specifically, as seen in FIG. 10, the dowel cap 500 includes (defines) an internal cavity 502. which extends vertically into the dowel cap 500 in (generally) orthogonal (perpendicular) relation to the longitudinal axis X and is configured to receive (house, accommodate) the clevis 800, the drive shaft 900, and the toggle 1100 such that the clevis 800, the drive shaft 900, and the toggle 1100 are movable within the internal cavity 502 during reconfiguration of the end effector 10 between the passive and active configurations, as described in further detail below.

In the illustrated embodiment, the internal cavity 502 defines a (generally) D-shaped transverse cross-sectional configuration, which facilitates access to, and connection of, the clevis 800 and the toggle 1100, which is described in further detail below. Embodiments in which the particular transverse cross-sectional configuration of the internal cavity 502 may be varied are also envisioned herein, however. For example, an embodiment in which the internal cavity 502 may define a (generally) ovate transverse cross-sectional configuration would not be beyond the scope of the present disclosure.

In the illustrated embodiment, the dowel cap 500 includes (e.g., is formed partially or entirely from) a non-metallic material (e.g., nylon). It should be appreciated, however, that the dowel cap 500 may include any suitable material (or combination of materials), and that the dowel cap 500 may be formed through any suitable method of manufacture (e.g., 3-D printing, machining, casting, etc.).

The dowel cap 500 defines a proximal end 504 that is (generally) planar (e.g., flat) in configuration and a distal end 506 that is arcuate (curved) in configuration. More specifically, the distal end 506 of the dowel cap 500 defines an outer contour 508 that mates with the chamfered (angled, beveled) tips 320, 322 (FIG. 9) of the respective legs 314, 316 defined by the distal end 306 of the main housing 300, which further reduces and smooths the profile of the end effector 10 at the distal end 306 thereof so as to further reduce (if not entirely eliminate) the presence of hard corners.

In order to facilitate connection of the dowel cap 500 to the main housing 300 and the dowel 600, the dowel cap 500 includes apertures 510, 512 (FIGS. 9, 10). More specifically, the apertures 510 extend into (and through) a pair of sidewalls 514, 516 of the dowel cap 500, which are (generally) planar (e.g., flat) in configuration, and the apertures 512 extend into (and through) respective upper and lower end walls 518, 520 of the dowel cap 500, which are also (generally) planar (e.g., flat) in configuration. More specifically, the apertures 510 are configured to receive the mechanical fasteners 346 (FIGS. 2, 10), which extend through the main housing 300 and into the dowel cap 500, and the apertures 512 are configured to receive corresponding mechanical fasteners 522 (e.g., screws, pins, clips, etc.), which extend through the dowel cap 500 and into the dowel 600.

The dowel 600 (FIGS. 1-4, 7, 9, and 11) is configured to interface with the vehicle door 3 via insertion into the window channel 4 and is connected (secured) to the dowel cap 500, whereby the dowel cap 500 operatively (e.g., indirectly) connects the dowel 600 to the main housing 300. More specifically, the dowel 600 extends vertically from the dowel cap 500 in (generally) orthogonal (perpendicular) relation to the longitudinal axis X of the end effector 10.

In the illustrated embodiment, the dowel 600 includes (e.g., is formed partially or entirely from) a non-metallic material (e.g., nylon). It should be appreciated, however, that the dowel 600 may include any suitable material (or combination of materials), and that the dowel 600 may be formed through any suitable method of manufacture (e.g., 3-D printing, machining, casting, etc.).

As seen in FIG. 9, the dowel 600 defines (and extends along) a longitudinal axis Y and includes a dowel shaft 602 with respective upper and lower ends 604, 606 that defines a longitudinal recess 608.

The dowel shaft 602 includes apertures 610 that extend into the upper end 604 thereof and which are configured to receive the mechanical fasteners 522 such that the mechanical fasteners 522 (FIGS. 2, 10) extend through the dowel cap 500 and into the dowel 600. As seen in FIG. 9, the upper end 604 of the dowel shaft 602 is (generally) planar (e.g., flat) in configuration, which facilitates mating engagement of (contact between) the upper end 604 of the dowel shaft 602 and the lower end wall 520 of the dowel cap 500.

The lower end 606 of the dowel shaft 602 includes a tip portion 612 with a frustoconical configuration, which reduces the surface area of the end effector 10 in contact with vehicle door 3 to inhibit (if not entirely prevent) paint drip. The tip portion 612 establishes and maintains secured engagement (contact) between the vehicle door 3 and the end effector 10 via insertion into the window channel 4. Upon insertion of the dowel 600 (e.g., the tip portion 612) into the vehicle door 3 (e.g., the window channel 4), the frustoconical configuration of the tip portion 612 allows for relative movement between the vehicle door 3 and the dowel 600 during manipulation of the vehicle door 3 by the end effector 10. More specifically, as the end effector 10 moves towards and away from the vehicle 2 during opening and closure of the vehicle door 3, the vehicle door 3 pivots about the tip portion 612, whereby the longitudinal axis Y of the dowel 600 also defines an axis of relative rotation between the end effector 10 and the vehicle door 3.

It is also envisioned that frustoconical configuration of the tip portion 612 may allow for lateral movement (displacement) (e.g., sliding) of the dowel 600 within the window channel 4 during opening and closure of the vehicle door 3, which not only allows for additional range of motion, but reduces stresses applied to the robotic unit 1 (FIG. 1) and/or to the vehicle door 3. The frustoconical configuration of the tip portion 612 facilitates not only relative rotation between the end effector 10 and the vehicle door 3, but relative linear movement (displacement) as well.

The frustoconical configuration of the tip portion 612 also promotes repeatable and predictable positive engagement (contact) with the vehicle door 3 by guiding the tip portion 612 into proper positioning within the window channel 4 when compared to known end effectors, which are often generally paddle-shaped members that are generally linear (planar, flat) in configuration. This repeatable and predictable placement reduces (if not entirely eliminates) halts during operation of the robotic unit 1 (FIG. 1) that may otherwise be caused by misplacement and false indications of detection and/or engagement (contact) between the end effector 10 and the vehicle door 3, thus reducing the overall time required for task completion and the associated costs.

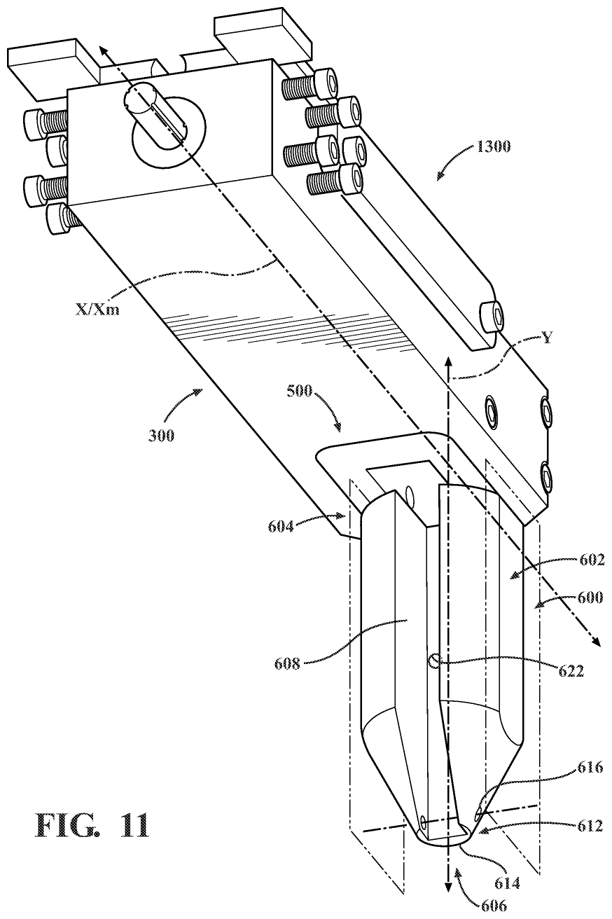

As seen in FIGS. 9 and 11, the tip portion 612 of the dowel 600 tapers inwardly to define an apex 614 and includes an aperture 616. The aperture 616 is configured to receive a pivot member 618 (e.g., a pin 620) such that the pivot member 618 extends through the dowel 600 and the toggle 1100, thereby allowing the toggle 1100 to pivot in relation to the dowel 600 during reconfiguration of the end effector 10 between the passive and active configurations, as described in further detail below.

The longitudinal recess 608 extends between the respective upper and lower ends 604, 606 of the dowel shaft 602 and is in communication with the internal cavity 502 (FIG. 10) defined by the dowel cap 500. The longitudinal recess 608 extends into the dowel shaft 602 in the distal direction and is configured to (partially) receive the toggle 1100. The longitudinal recess 608 thus accommodates movement (displacement) of the toggle 1100 as the toggle 1100 pivots in relation to the dowel 600 during reconfiguration of the end effector 10 between the passive and active configurations.

As seen in FIG. 11, the dowel 600 includes (defines) one or more recesses 622 that extend axially into the dowel shaft 602 (e.g., in the distal direction) and which are configured to receive the biasing member(s) 700 (FIG. 9). More specifically, the recess(es) 622 extend in (generally) parallel relation to the longitudinal axis X of the end effector 10 and in (generally) orthogonal (perpendicular) relation to the longitudinal axis Y of the dowel 600.

The clevis 800 (FIGS. 3, 4, 9, 10) defines respective proximal (first) and distal (second) ends 802, 804 and includes a body 806, which defines a generally U-shaped cross-sectional configuration. More specifically, the body 806 includes a base 808 and a pair of fingers 810, 812 that extend distally from the base 808 so as to define a gap 814 therebetween, which is configured to receive the toggle 1100 such that the toggle 1100 extends into the clevis 800 within the internal cavity 502 (FIG. 10) defined by the dowel cap 500.

In the illustrated embodiment, the clevis 800 includes (e.g., is formed partially or entirely from) a non-metallic material (e.g., nylon). It should be appreciated, however, that the clevis 800 may include any suitable material (or combination of materials), and that the clevis 800 may be formed through any suitable method of manufacture (e.g., 3-D printing, machining, casting, etc.).

The proximal end 802 of the clevis 800 is connected (secured) to the drive shaft 900 such that axial (linear) movement (displacement) of the clevis 800 (e.g., within the internal cavity 502 defined by the dowel cap 500) causes corresponding axial (linear) movement (displacement) of the drive shaft 900 along the axis of movement Xm. It is envisioned that the clevis 800 and the drive shaft 900 may be connected (secured) in any suitable manner. For example, in the illustrated embodiment, the base 808 of the clevis 800 defines an opening 816 (FIGS. 3, 4), which is configured to receive the drive shaft 900 such that the drive shaft 900 extends into the clevis 800, and one or more apertures 818, which are configured to receive one or more corresponding mechanical fasteners 820 (e.g., e.g., screws, pins, clips, etc.) such that the mechanical fastener(s) 820 extend through the clevis 800 and into the drive shaft 900. Additionally, or alternatively, it is envisioned that the clevis 800 and the drive shaft 900 may be connected (secured) via an adhesive, in an interference (press) fit, etc., which may either replace or supplement the connection between the clevis 800 and the drive shaft 900 established by the mechanical fastener(s) 820.

In the illustrated embodiment, the clevis 800 and the drive shaft 900 are connected (secured) by a single mechanical fastener 820. It should be appreciated, however, that the particular number of mechanical fasteners 820 and, thus, the particular number of apertures 818 defined by the clevis 800, may be altered in various embodiments. For example, an embodiment in which the clevis 800 and the drive shaft 900 may be connected (secured) by multiple mechanical fasteners 820 is also envisioned herein and would not be beyond the scope of the present disclosure.

As seen in FIG. 9, the fingers 810, 812 define respective apertures 822, 824, which are configured to receive a pivot member 826 (e.g., a pin 828) such that the pivot member 826 extends through the fingers 810, 812 and the toggle 1100 and spans the gap 814, thereby pivotably connecting the distal end 804 of the clevis 800 to the toggle 1100. The clevis 800 thus operatively (e.g., indirectly) connects the drive shaft 900 to the toggle 1100 such that movement (displacement) of the toggle 1100 causes corresponding movement (displacement) of the clevis 800 and the drive shaft 900 (e.g., along the axis of movement Xm) during reconfiguration of the end effector 10 between the passive and active configurations, whereby the clevis 800 translates pivotable movement (displacement) of the toggle 1100 into axial (linear) movement (displacement) of the drive shaft 900.

The drive shaft 900 (FIGS. 3, 4, 6, 7, and 9) defines respective proximal and distal ends 902, 904 and includes (e.g., is formed partially or entirely from) a metallic material (e.g., stainless steel). As described in further detail below, the drive shaft 900 supports the coupling 1000 and the interrupter 1400 such that axial (linear) movement (displacement) of the drive shaft 900 causes corresponding axial (linear) movement (displacement) of the coupling 1000 and the interrupter 1400 during reconfiguration of the end effector 10 between the passive and active configurations.

The proximal end 902 of the drive shaft 900 includes a pair of apertures 906i, 906ii (FIG. 9), and extends through the main housing 300 and into (e.g., through) the window 116 (FIG. 5) in the proximal end wall 102 of the mounting bracket 100, which facilitates axial (linear) movement (displacement) of the drive shaft 900 during reconfiguration of the end effector 10 between the passive and active configurations.

The distal end 904 of the drive shaft 900 is connected (secured) to the clevis 800, as discussed above, whereby axial (linear) movement (displacement) of the clevis 800 (e.g., within the internal cavity 502 defined by the dowel cap 500) causes corresponding axial (linear) movement (displacement) of the drive shaft 900. More specifically, the distal end 904 of the drive shaft 900 defines an aperture 908 that is configured to receive the mechanical fastener 820 such that the mechanical fastener 820 extends through the clevis 800 and into the drive shaft 900.

The coupling 1000 (FIGS. 3, 4, 7, and 9) is (directly) connected (secured) to the drive shaft 900 and the interrupter 1400, whereby the coupling 1000 operatively (e.g., indirectly) connects the interrupter 1400 to the drive shaft 900 such that movement (displacement) of the drive shaft 900 causes corresponding movement (displacement) of the interrupter 1400, as described in further detail below.

The coupling 1000 includes (e.g., is formed partially or entirely from) a metallic material (e.g., stainless steel) and is located within the internal compartment 324 (FIGS. 7, 9) defined by the main housing 300. With reference to FIG. 9 in particular, the coupling 1000 includes: an axial passage 1002; a plurality of apertures 1004; and an axial channel 1006.

The axial passage 1002 extends through the coupling 1000 in (generally) parallel relation to the longitudinal axis X of the end effector 10 and is configured to receive the drive shaft 900 such that the drive shaft 900 extends into (e.g., through) the coupling 1000.

The apertures 1004 are configured to receive corresponding mechanical fasteners 1008, 1010, which are accessed through the window 334 in the main housing 300. The mechanical fasteners 1008, 1010 (directly) connect (secure) the coupling 1000 to both the drive shaft 900 and the interrupter 1400 such that axial (linear) movement (displacement) of the drive shaft 900 causes corresponding, concomitant movement (displacement) of the coupling 1000 and, thus the interrupter 1400. In the illustrated embodiment, the coupling 1000 includes a proximal (first) pair of apertures 1004i, 1004ii that are configured to receive a proximal (first) pair of corresponding mechanical fasteners 1008i, 1008ii and a distal (second) pair of apertures 1004iii, 1004iv that are configured to receive a distal (second) pair of corresponding mechanical fasteners 1010i, 1010ii. More specifically, the mechanical fasteners 1008i, 1008ii extend through the apertures 1004i, 1004ii and into the apertures 906i, 906ii in the proximal end 902 of the drive shaft 900, and the mechanical fasteners 1010i, 1010ii extend through the apertures 1004iii, 1004iv and into an axial slot 1402 in the interrupter 1400, respectively. It should be appreciated, however, that the particular number of mechanical fasteners 1008, 1010 used to connect (secure) the coupling 1000 to the drive shaft 900 and the interrupter 1400 may be altered in various embodiments. For example, an embodiment of the end effector 10 in which the coupling 1000 may be connected (secured) to the drive shaft 900 by a single mechanical fastener 1008 and to the interrupter 1400 by a single mechanical fastener 1010 is also envisioned herein and would not be beyond the scope of the present disclosure.

In certain embodiments of the disclosure, it is envisioned that the drive shaft 900 and the coupling 1000 may be configured such that the drive shaft 900 is insertable into the coupling 1000 in an interference (press) fit, which may replace or supplement the mechanical connection between the drive shaft 900 and the coupling 1000 established by the mechanical fasteners 1008.

The axial channel 1006 extends in (generally) parallel relation to the longitudinal axis X of the end effector 10 and is configured to receive the interrupter 1400. More specifically, upon assembly of the end effector 10, the interrupter 1400 is located within the axial channel 1006 such that the interrupter 1400 extends vertically through, and is exposed from, the coupling 1000.

The toggle 1100 (FIGS. 1-4, 7, 9) is configured for engagement (contact) with the vehicle door 3 (FIG. 1) and is received by, and extends (partially) into, the longitudinal recess 608 (FIGS. 9, 11) defined by the dowel 600, as indicated above, whereby the toggle 1100 extends in transverse relation to both the longitudinal axis X of the end effector 10 and the longitudinal axis Y of the dowel 600. As described further detail below, the toggle 1100 facilitates not only reconfiguration of the end effector 10 between the passive and active configurations, but repositioning of the interrupter 1400 as well.

The toggle 1100 includes: an upper end 1102; a lower end 1104; a proximal end 1106, which defines a bearing surface 1108; and a distal end 1110, which defines an end face 1112. In the illustrated embodiment, the toggle 1100 includes (e.g., is formed partially or entirely from) a non-metallic material (e.g., nylon). It should be appreciated, however, that the toggle 1100 may include any suitable material (or combination of materials), and that the toggle 1100 may be formed through any suitable method of manufacture (e.g., 3-D printing, machining, casting, etc.).

As seen in FIGS. 3, 4, and 9, the upper end 1102 of the toggle 1100 defines a (vertical) slot 1114 that is configured to receive the pivot member 826, thereby pivotably connecting the toggle 1100 to the clevis 800.

The lower end 1104 of the toggle 1100 defines an aperture 1116 that is configured to receive the pivot member 618, thereby pivotably connecting the toggle 1100 to the dowel 600. The pivotable connection between the dowel 600 and the toggle 1100 facilitates repositioning of the toggle 1100 between a normal (first, initial) position (FIG. 3), which corresponds to the passive configuration of the end effector 10, and a deflected (second, subsequent) position (FIG. 4), which corresponds to the active configuration of the end effector 10. When the toggle 1100 is in the normal position (e.g., prior to engagement (contact) of the end effector 10 with the vehicle door 3), the end face 1112 extends at an acute angle α (FIG. 3) in relation to the longitudinal axis Y of the dowel 600 (whereby the toggle 1100 extends transversely in relation to both the longitudinal axis X of the end effector 10 and the longitudinal axis Y of the dowel 600). When the toggle 1100 is in the deflected position (e.g., upon engagement (contact) of the end effector 10 with the vehicle door 3), however, the end face 1112 extends in (generally) parallel relation to the longitudinal axis Y of the dowel 600 and in (generally) orthogonal relation to the longitudinal axis X of the end effector 10.

In the illustrated embodiment, the end effector 10 is configured such that the angle α lies (substantially) within the range of (approximately) 10 degrees to (approximately) 45 degrees. Embodiments in which the angle α may lie outside the disclosed range, however, are also envisioned herein and would not be beyond the scope of the present disclosure.

As the toggle 1100 is repositioned between the normal and deflected positions, by virtue of the pivotable connection between the toggle 1100 and the dowel 600, the toggle 1100 is displaced vertically (e.g., along the longitudinal axis Y) in relation to the clevis 800 and the pivot member 826, which is accommodated by the slot 1114 in the upper end 1102 of the toggle 1100. More specifically, as the toggle 1100 is repositioned from the normal position into the deflected position, the toggle 1100 is displaced vertically upward (e.g., towards the upper end wall 518 of the dowel cap 500), during which, the pivot member 826 moves vertically downward through the slot 1114, and as the toggle 1100 is repositioned from the deflected position into the normal position, the toggle 1100 is displaced vertically downward (e.g., away from the upper end wall 518 of the dowel cap 500), during which, the pivot member 826 moves vertically upward through the slot 1114.

The bearing surface 1108 is configured for engagement (contact) with the outer panel 6 (FIG. 1) of the vehicle door 3 and includes a non-linear (e.g., curved, arcuate) configuration, whereby the toggle 1100 includes a (generally) C-shaped cross-sectional configuration and defines a variable width W (FIG. 9). More specifically, the width W of the toggle 1100 increases as distance from the respective upper and lower ends 1102, 1104 increases and is maximized at a midline M of the toggle 1100, which is spaced (approximately) equidistant from the respective upper and lower ends 1102, 1104.

The end face 1112, by contrast, is (generally) planar (e.g., flat) in configuration and includes (defines) one or more recesses 1118 (FIG. 9). The recess(es) 1118 extend axially into the toggle 1100 in the proximal direction and are configured to receive the biasing member(s) 700 such that the biasing member(s) 700 are positioned (located) between, and are in engagement (contact) with, the toggle 1100 and the dowel 600. More specifically, each biasing member 700 include a proximal (first) end 704, which is configured for insertion into a corresponding recess 1118 in the toggle 1100, and a distal (second) end 706, which is configured for insertion into a corresponding recess 622 in the dowel shaft 602. The proximal and distal ends 704, 706 of the biasing member(s) 700 are thus configured for respective engagement (contact) with the toggle 1100 and the dowel 600. Engagement (contact) of the biasing member(s) 700 with the dowel 600 and the toggle 1100 facilitates compression of the biasing member(s) 700 therebetween during repositioning of the toggle 1100 from the normal position into the deflected position, which applies a biasing force to the toggle 1100 that biases the toggle 1100 towards the normal position (FIG. 3).

In the illustrated embodiment, the end effector 10 is shown as including a single biasing member 700 and, thus, a single recess 622 and a single recess 1118. Embodiments in which the end effector 10 may include two or more biasing members 700, two or more recesses 622, and two or more recesses 1118 are also envisioned herein, however, and would not be beyond the scope of the present disclosure.

The detection module 1200 (FIGS. 3, 4, 7, 8, and 12-14) is secured to the main housing 300 via the mechanical fasteners 348 (FIGS. 3, 4, 7) which extend through the detection module 1200 and into the main housing 300. The detection module 1200 receives the transmission member 1600 and the interrupter 1400 such that the interrupter 1400 is axially movable through (within) the detection module 1200 during reconfiguration of the end effector 10 between the passive and active configurations. The detection module 1200 includes a detection module housing 1202 with respective proximal and distal ends 1204, 1206 and a detection module cover 1208 with respective proximal and distal ends 1210, 1212 that is connected (secured) to the detection module housing 1202, whereby the detection module cover 1208 is positioned between the detection module housing 1202 and the main housing 300.

In the illustrated embodiment, each of the detection module housing 1202 and the detection module cover 1208 include (e.g., are formed partially or entirely from) a non-metallic material (e.g., polyvinyl chloride). It should be appreciated, however, that the detection module housing 1202 and the detection module cover 1208 may include any suitable material (or combination of materials), and that the detection module housing 1202 and the detection module cover 1208 may be formed through any suitable method of manufacture (e.g., 3-D printing, machining, casting, etc.).

The detection module housing 1202 includes (defines): a first (feed) groove 1214; a second (return) groove 1216; a (first) axial channel 1218; and apertures 1220i-1220iv.

The grooves 1214, 1216 are formed in a lower (inner, bottom) surface 1222 of the detection module housing 1202 and configured to receive (accommodate) the transmission member 1600 such that the transmission member 1600 extends into and through the detection module 1200 via the detection module housing 1202. The groove 1214 is configured to receive a feed section 1600f of the transmission member 1600 and defines an ingress 1224, which extends in (generally) parallel relation to the axial channel 1218, and an egress 1226, which extends into (is in communication with) the axial channel 1218. The groove 1216 is configured to receive a return section 1600r of the transmission member 1600 and defines an ingress 1228, which extends in (generally) parallel relation to the axial channel 1218, and an egress 1230, which extends into (is in communication with) the axial channel 1218.

As seen in FIGS. 12-14, the grooves 1214, 1216 are non-linear in configuration and are mirror-images of each other, whereby the detection module housing 1202 is (generally) symmetrical about the axial channel 1218. More specifically, the grooves 1214, 1216 each include a (generally) J-shaped configuration and are configured such that the ingresses 1224, 1228 extend in (generally) parallel relation and such that the corresponding respective egresses 1226, 1230 extend in (generally) orthogonal (perpendicular) relation thereto (e.g., the egress 1226 is oriented in (generally) orthogonal relation to the ingress 1224 and the egress 1230 is oriented in (generally) orthogonal relation to the ingress 1228). The egresses 1226, 1230 are thus directed towards each other, in facing relation, which facilitates communication between the respective feed and return sections 1600f, 1600r of the transmission member 1600 and transmission of the detection signal 1602 (FIGS. 13, 14) across the detection module 1200 (e.g., from the feed section 1600f, across the axial channel 1218, and into the return section 1600r).

The axial channel 1218 extends between the grooves 1214, 1216 and is configured to receive (accommodate) the interrupter 1400. More specifically, the axial channel 1218 includes a proximal (first) end 1232, which is located (axially) between the ingresses 1224, 1228 and the egresses 1226, 1230, and a distal (second) end 1234, which is located distally beyond the egresses 1226, 1230.

The apertures 1220i-1220iv are configured to receive corresponding mechanical fasteners 3481-348iv (FIG. 7), respectively, such that the mechanical fasteners 3481-348iv extend through the detection module housing 1202. In the illustrated embodiment, the apertures 1220i-1220iv include an elongated, non-circular cross-sectional configuration, which allows for axial repositioning of the detection module housing 1202 (e.g., along the longitudinal axis X of the end effector 10) to increase precision in the relative positioning of the transmission member 1600 and the interrupter 1400, which is described in further detail below. Embodiments in which the apertures 1220i-1220iv may each include a circular cross-sectional configuration, however, are also envisioned herein and would not be beyond the scope of the present disclosure.

The detection module cover 1208 is located between the main housing 300 and the detection module housing 1202 and is connected (secured) to the detection module housing 1202 so as to enclose the grooves 1214, 1216 and thereby conceal and protect the transmission member 1600 (e.g., the feed section 1600f and the return section 1600r). The detection module cover 1208 includes (defines) a (second) axial channel 1236 and apertures 12381-1238vi, and is (generally) symmetrical about the axial channel 1236.

The axial channel 1236 is (generally) aligned with, and extends in (generally) parallel relation to, the axial channel 1120 defined by the detection module housing 1202. The axial channel 1236 is configured to receive (accommodate) the interrupter 1400 such that the interrupter 1400 extends therethrough and into the axial channel 1218, which facilitates movement of the interrupter 1400 through the axial channels 1218, 1236 during reconfiguration of the end effector 10 between the passive and active configurations.

The apertures 12381-1238iv are configured to receive the mechanical fasteners 348i-348iv such that the mechanical fasteners 3481-348iv extend through the detection module housing 1202 via the apertures 1220i-1220iv, through the detection module cover 1208, and into corresponding apertures 342i-342iv in the upper wall 312 of the main housing 300, and the apertures 1238v, 1238vi are configured to receive corresponding mechanical fasteners 348v, 348vi such that the mechanical fasteners 348v, 348vi extend through the detection module cover 1208 and into corresponding apertures 342v, 342vi in the upper wall 312 of the main housing 300, respectively. The mechanical fasteners 348 thus connect (secure) the detection module housing 1202 and the detection module cover 1208 to each other and to the main housing 300.

The top cover 1300 (FIGS. 1-4, 7, 8, and 11) is connected (secured) to the main housing 300 and is configured to conceal and protect the internal components of the end effector 10 (e.g., the guide bearings 400, the drive shaft 900, the coupling 1000, the detection module 1200, and the interrupter 1400). In the illustrated embodiment, the top cover 1300 includes (e.g., is formed partially or entirely from) a non-metallic material (e.g., nylon). It should be appreciated, however, that the top cover 1300 may include any suitable material (or combination of materials), and that the top cover 1300 may be formed through any suitable method of manufacture (e.g., 3-D printing, machining, casting, etc.).

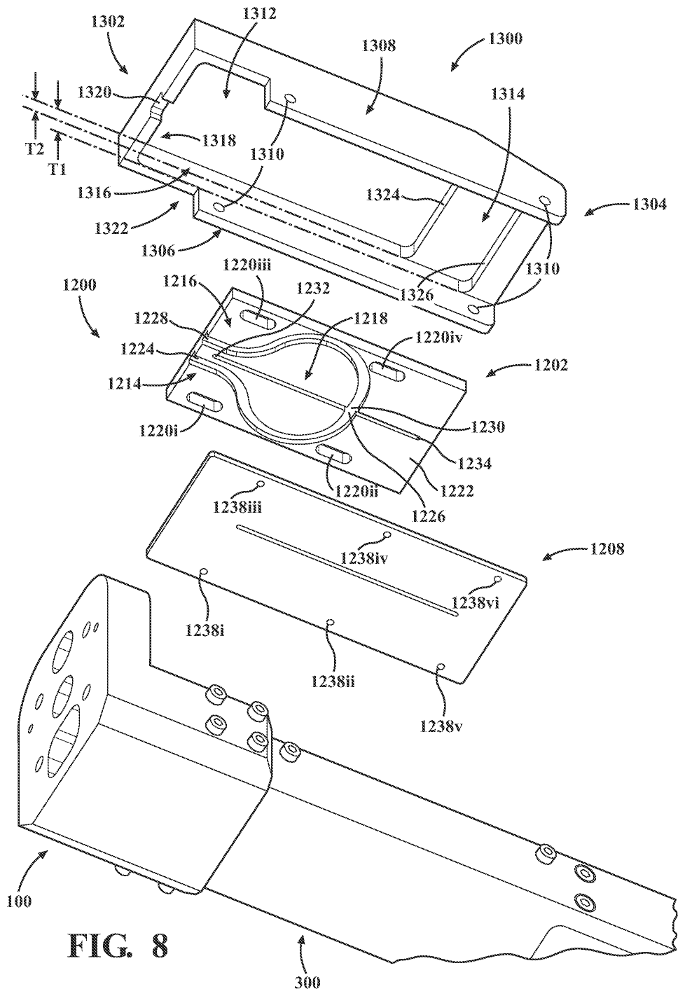

With reference to FIG. 8 in particular, the top cover 1300 includes: a proximal end 1302; a distal end 1304; sidewalls 1306, 1308, which include (define) apertures 1310; and recesses 1312, 1314, which are formed on an inner surface 1316 thereof and are configured to receive the detection module housing 1202 and the detection module cover 1208, respectively.

The proximal end 1302 of the top cover 1300 includes a proximal end wall 1318, which defines a relief 1320 that is configured to receive (accommodate) the transmission member 1600, and a notch (cutout) 1322, which extends vertically into the sidewalls 1306, 1308 in (generally) orthogonal relation to the longitudinal axis X of the end effector 10 and in (generally) parallel relation to the longitudinal axis Y of the dowel 600. The notch 1322 is configured in correspondence with the mounting bracket 100 such that the mounting bracket 100 extends into and is (partially) received by (positioned within) the notch 1322, whereby the mounting bracket 100 supports the proximal end 1302 of the top cover 1300 upon assembly of the end effector 10.

The distal end 1304 of the top cover 1300 includes a chamfered (angled, beveled) configuration that tapers inwardly as distance from the proximal end 1302 increases. The chamfered configuration of the distal end 1304 of the top cover 1300 reduces the overall profile of the end effector 10 and further reduces (if not entirely eliminates) the presence of hard corners.

The apertures 1310 in the sidewalls 1306, 1308 of the top cover 1300 are located distally of the notch 1322 and facilitate connection of the top cover 1300 to the main housing 300. More specifically, the apertures 1310 are configured to receive the mechanical fasteners 344 (FIG. 2) such that the mechanical fasteners 344 extend through the apertures 1310 and into the apertures 338 (FIGS. 7, 9) in the sidewalls 308, 310 of the main housing 300. As seen in FIG. 8, the apertures 1310 are spaced vertically from (e.g., below) the recesses 1312, 1314, which avoids contact between the mechanical fasteners 344 and the detection module housing 1202 and the detection module cover 1208, thereby inhibiting (if not entirely preventing) disruption of the detection module 1200 during assembly of the end effector 10.

The recesses 1312, 1314 extend vertically (upward) into to the top cover 1300 in (generally) orthogonal relation to the longitudinal axis X of the end effector 10 and in (generally) parallel relation to the longitudinal axis Y of the dowel 600. In order to facilitate reception of the detection module housing 1202 and the detection module cover 1208, the recess 1312 extends into the top cover 1300 so as to define a (first) depth T1 and a (first) lip 1324, and the recess 1314 extends into the top cover 1300 so as to define a (second) depth T2, which is less than the depth T1, and a (second) lip 1326. Upon assembly of the end effector 10, the proximal ends 1204, 1210 of the detection module housing 1202 and the detection module cover 1208 are positioned adjacent to (e.g., in contact with) the proximal end wall 1318 of the top cover 1300, respectively, and the distal ends 1206, 1212 of the detection module housing 1202 and the detection module cover 1208 are positioned adjacent to (e.g., in contact with) the lips 1324, 1326, respectively, which inhibits (if not entirely prevents) relative axial movement between the top cover 1300 and the detection module 1200 (e.g., along the longitudinal axis X of the end effector 10).

With reference now to FIGS. 3, 4, 7, 9, 13, and 14, the interrupter 1400 will be discussed, which includes a body portion 1404 and a flag 1406. As indicated above, the interrupter 1400 is supported by drive shaft 900 such that the interrupter 1400 is axially (linearly) and concomitantly movable with the drive shaft 900 and the coupling 1000 as the toggle 1100 is repositioned between the normal position (FIG. 3) and the displaced position (FIG. 4) during reconfiguration of the end effector 10 between the passive and active configurations. More specifically, the interrupter 1400 is movable (repositionable) in (generally) parallel relation to the longitudinal axis X of the end effector 10 along the axis of movement Xm between a blocking (normal, first) position (FIGS. 3, 13), which corresponds to the normal position of the toggle 1100 and the passive configuration of the end effector 10, and a transmission (displaced, second) position (FIGS. 4, 14), which corresponds to the displaced position of the toggle 1100 and the active configuration of the end effector 10. In the blocking position, the flag 1406 of the interrupter 1400 is located (positioned) between the respective feed and return sections 1600f, 1600r of the transmission member 1600 and in (general) axial alignment with the detection signal 1602 so as to obstruct or otherwise interfere with transmission of the detection signal 1602 across the detection module 1200, as seen in FIG. 13, thereby interrupting circuit completion so as to inform the robotic unit 1 that the vehicle door 3 has not been engaged by the end effector 10. In the transmission position, the flag 1406 of the interrupter 1400 is spaced axially from (e.g., is positioned distally of) the respective feed and return sections 1600f, 1600r of the transmission member 1600 such that the interrupter 1400 is misaligned (out of axial alignment) with the detection signal 1602, as seen in FIG. 14, thereby permitting unobstructed transmission of the detection signal 1602 across the detection module 1200 and circuit completion so as to confirm the presence of the vehicle door 3 and engagement (contact) between the vehicle door 3 and the end effector 10 for the robotic unit 1.

In the illustrated embodiment, the interrupter 1400 includes (e.g., is formed partially or entirely from) a non-metallic material (e.g., polylactic acid). It should be appreciated, however, that the interrupter 1400 may include any material (or combination of materials) suitable for the intended purpose of interrupting the detection signal 1602, and that the interrupter 1400 may be formed through any suitable method of manufacture (e.g., 3-D printing, machining, casting, etc.).

The body portion 1404 extends in generally parallel relation to the longitudinal axis X and includes (defines) the axial slot 1402, which extends in (generally) parallel relation to the longitudinal axis X of the end effector 10 and is configured to receive the mechanical fasteners 1010i, 1010ii (FIG. 9) to thereby secure the interrupter 1400 to the coupling 1000. The interrupter 1400 is thus operatively (e.g., indirectly) connected (secured) to the toggle 1100 via the clevis 800, the drive shaft 900, and the coupling 1000, whereby movement (displacement) of the toggle 1100 between the normal position and the deflected position causes corresponding movement (displacement) of the interrupter 1400 between the blocking position and the transmission position, and movement (displacement) of the toggle 1100 between the deflected position and the normal position causes corresponding movement (displacement) of the interrupter 1400 between the transmission position and the blocking position.

As seen in FIG. 9, the axial slot 1402 is elongate in configuration, which allows for adjustments in the position of the interrupter 1400 in relation to the coupling 1000 and, thus, the respective feed and return sections 1600f, 1600r of the transmission member 1600, in order to facilitate positioning of the interrupter 1400 in (general) alignment with the detection signal 1602 when the interrupter 1400 is in the blocking position.

The flag 1406 extends vertically (upward) from the body portion 1404, whereby the flag 1406 extends in (generally) orthogonal (perpendicular) relation to the body portion 1404, the longitudinal axis X, and the axis of movement Xm, which facilitates positioning of the flag 1406 between the respective feed and return sections 1600f, 1600r of the transmission member 1600 when the interrupter 1400 is in the blocking position. As such, during repositioning of the interrupter 1400 between the blocking and transmission positions, the flag 1406 moves out of and into alignment with the detection signal 1602 to allow for completion and interruption of the circuit in correspondence with engagement and disengagement of the end effector 10 and the vehicle door 3.

With reference now to FIGS. 1-14, a method of using and operating the end effector 10 to detect engagement (contact) between the robotic unit 1 and the vehicle door 3 will be discussed.

Initially, the robotic unit 1 (FIG. 1) is positioned such that the end effector 10 is located in proximity to the vehicle door 3, and vertically above, the window channel 4. More specifically, the end effector 10 is positioned such that the dowel 600 is vertically aligned with the window channel 4 and such that the toggle 1100 is vertically aligned with the outer panel 6 of the vehicle door 3, as seen in FIG. 3. The end effector 10 is then moved (lowered) along a (generally) vertical first axis E (e.g., an engagement axis) into contact with the vehicle door 3 such that the end effector 10 is inserted into the window channel 4, whereby the bearing surface 1108 (FIGS. 1, 3, 4) on the toggle 1100 is brought into engagement (contact) with the outer panel 6 and the tip portion 612 of the dowel 600 and the lower end 1104 of the toggle 1100 are inserted into the window channel 4.

As the dowel 600 and the toggle 1100 are advanced vertically (downward) into the window channel 4, contact between the bearing surface 1108 and the outer panel 6 causes repositioning of the toggle 1100 from the normal position (FIG. 3) into the deflected position (FIG. 4), during which, the toggle 1100 pivots in relation to the dowel 600 about the pivot member 618, and the upper end 1102 thereof is moved (displaced) distally. As the upper end 1102 of the toggle 1100 is moved (displaced) distally, the toggle 1100 is inserted further into the longitudinal recess 608 (FIGS. 9, 11) defined by the dowel 600, which causes compression of the biasing member 700 between the toggle 1100 and the dowel 600, thereby increasing the biasing force in the biasing member 700.

As a result of the connection established between the upper end 1102 of the toggle 1100 and the clevis 800 by the pivot member 826 (FIGS. 3, 4, 9, 10), distal movement (displacement) of the upper end 1102 of the toggle 1100 causes corresponding (distal) movement (displacement) of the clevis 800 (e.g., within the internal cavity 502 (FIG. 10) defined by the dowel cap 500), during which the upper end 1102 of toggle 1100 pivots in relation to the clevis 800 about the pivot member 826.

Distal movement (displacement) of the clevis 800 causes corresponding (distal) movement (displacement) of the drive shaft 900 due to the connection established therebetween by the mechanical fastener 820 (FIGS. 3, 4, 9), thereby transitioning the end effector 10 from the passive configuration (FIG. 3) into the active configuration (FIG. 4). During movement (displacement) of the drive shaft 900, the draft shaft 900 moves through the guide bearings 400, which (generally) restrict the drive shaft 900 to linear motion. Restricting the drive shaft 900 to linear motion inhibits (if not entirely prevents) contact between the flag 1406 (FIGS. 7, 9, 13, 14) and the detection module 1200 (e.g., the axial channels 1236, 1218 respectively defined by the detection module cover 1208 and the detection module housing 1202) in order to facilitate proper operation of the detection module 1200 (e.g., transmission and interruption of the detection signal 1602), which may otherwise be compromised via contact between the flag 1406 and the detection module cover 1208 and/or the detection module housing 1202.

Due to the connection between the drive shaft 900 and the coupling 1000 established by the mechanical fasteners 1008i, 1008ii (FIG. 9) and the connection between the coupling 1000 and the interrupter 1400 established by the mechanical fasteners 1010i, 1010ii, distal movement (displacement) of the drive shaft 900 causes corresponding distal movement (displacement) of the coupling 1000, and, thus, the interrupter 1400 along a second axis (e.g., the axis of movement Xm), which extends in (generally) orthogonal relation to the first (engagement) axis E (FIG. 3). More specifically, distal movement (displacement) of the drive shaft 900 causes repositioning of the interrupter 1400 from the blocking position (FIGS. 3, 13) into the transmission position (FIGS. 4, 14), whereby the flag 1406 moved out of axial alignment with the detection signal 1602 transmitted from the feed section 1600f of the transmission member 1600 to the return section 1600r of the transmission member 1600. Movement (displacement) of the interrupter 1400 from the blocking position into the transmission position thus allows for transmission of the detection signal 1602 across the detection module 1200 and circuit completion, thereby confirming not only the presence of the vehicle door 3 (FIGS. 1, 3, 4), but positive engagement (contact) between the vehicle door 3 and the end effector 10, for the robotic unit 1. The interrupter 1400 thus provides an interface between the toggle 1100 and the detection module 1200 so as to convert the position and movement (displacement) of the toggle 1100 into a (fiber optic) indication of positive engagement (contact) between the robotic unit 1 (e.g., the end effector 10) and the vehicle door 3 (or the lack thereof).

Following circuit completion, the robotic unit 1 can proceed with opening and closure of the vehicle door 3 in accordance with its normal sequence of operation (e.g., as regulated by a controller (not shown)), and an additional robotic unit (not shown) can be utilized to paint the vehicle door 3 and/or the vehicle 2. During the painting process, air is communicated through the airline 1500 (FIGS. 3, 4, 10) and into the main housing 300 in order to pressurize the end effector 10. The air entering the main housing 300 is forced from the end effector 10 via the distal end 14 thereof (e.g., via the distal end 306 of the main housing 300 and/or the internal cavity 502 of the dowel cap 500) in order to inhibit (if not entirely prevent) paint overspray. In order to further protect the robotic unit 1 and the end effector 10, it is envisioned that the robotic unit 1 and the end effector 10 may be covered by a shroud (not shown) such that only the dowel 600 and the toggle 1100 are exposed therefrom.

After painting, the end effector 10 can be disengaged from the vehicle door 3, during which, the dowel 600 and the toggle 1100 are removed from the window channel 4. As the dowel 600 and the toggle 1100 are withdrawn from the window channel 4, the biasing member 700 expands under the influence of the biasing force and acts upon the toggle 1100 to urge the toggle 1100 in the proximal direction, thereby returning the toggle 1100 to the normal position. Proximal movement (displacement) of the toggle 1100 causes corresponding (proximal) movement (displacement) of the clevis 800, the drive shaft 900, the coupling 1000, and the interrupter 1400, thereby restoring the blocking position of the interrupter 1400 and the passive configuration (FIG. 3) of the end effector 10. As the blocking position of the interrupter 1400 is restored, the flag 1406 is aligned with the detection signal 1602, again interrupting circuit completion so as to confirm for the robotic unit 1 that the vehicle door 3 has been disengaged by the end effector 10. The aforedescribed sequence of operation can then be repeated to open and close additional vehicle doors 3 on the vehicle 2 to allow for additional painting as necessary.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 182°±25% (e.g., an angle that lies within the range of (approximately) 135° to (approximately) 225°) and the term “generally orthogonal” should be understood as referring to configurations in with the pertinent components are oriented so as to define an angle therebetween that is equal to 90°±25% (e.g., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An end effector for a robotic unit used to manipulate a vehicle door during manufacture, the end effector comprising:
a mounting bracket configured for connection to the robotic unit;
a main housing extending from the mounting bracket and defining a longitudinal axis of the end effector;
a detection module secured to the main housing;
a transmission member extending into the detection module and configured to generate a detection signal;
a dowel operatively connected to the main housing and configured for insertion into the vehicle door;
a toggle pivotably connected to the dowel and configured for engagement with the vehicle door such that the toggle is repositioned from a normal position to a deflected position upon engagement with the vehicle door and such that the toggle is repositioned from the deflected position to the normal position upon disengagement from the vehicle door; and
an interrupter operatively connected to the toggle such that movement of the toggle from the normal position into the deflected position causes corresponding movement of the interrupter in generally parallel relation to the longitudinal axis of the end effector from a blocking position, in which the interrupter interferes with the detection signal to thereby inhibit circuit completion, into a transmission position, in which the interrupter permits transmission of the detection signal across the detection module to thereby permit circuit completion and inform the robotic unit of engagement between the end effector and the vehicle door, and such that movement of the toggle from the deflected position into the normal position causes corresponding movement of the interrupter from the transmission position into the blocking position.

2. The end effector of claim 1, further comprising one or more biasing members positioned between the toggle and the dowel to bias the toggle towards the normal position.

3. The end effector of claim 1, further comprising a clevis pivotably connected to the toggle such that movement of the toggle between the normal position and the deflected position causes corresponding movement of the clevis.

4. The end effector of claim 3, further comprising a dowel cap connected to the main housing, the dowel being connected to the dowel cap such that the dowel extends from the dowel cap in generally orthogonal relation to the longitudinal axis of the end effector.

5. The end effector of claim 4, wherein the dowel cap defines an internal cavity configured to receive the clevis, whereby the dowel cap protects the clevis from paint overspray during manufacture of the vehicle door.

6. The end effector of claim 3, further comprising a drive shaft connected to the clevis such that movement of the clevis causes corresponding movement of the drive shaft.

7. The end effector of claim 6, further comprising one or more guide bearings received by the main housing and configured to receive the drive shaft such that the drive shaft extends into the one or more guide bearings, whereby the one or more guide bearings inhibit off-axis movement of the drive shaft.

8. The end effector of claim 6, wherein the interrupter is operatively connected to the drive shaft such that movement of the drive shaft causes corresponding movement of the interrupter.

9. The end effector of claim 8, further comprising a coupling located within the main housing, the drive shaft extending through the coupling.

10. The end effector of claim 9, wherein the coupling is directly connected to the drive shaft and the interrupter is directly connected to the coupling such that movement of the drive shaft causes corresponding movement of the coupling and the interrupter.

11. An end effector for a robotic unit used to manipulate a vehicle door during manufacture, the end effector comprising:
a detection module;
a transmission member extending into the detection module and configured to generate a detection signal such that the detection signal is transmitted across the detection module;
a toggle configured for engagement with the vehicle door via movement of the end effector along a first axis; and
an interrupter operatively connected to the toggle such that engagement of the toggle with the vehicle door and disengagement of the toggle from the vehicle door causes movement of the interrupter along a second axis extending in generally orthogonal relation to the first axis between a first position, in which the interrupter interferes with the detection signal to thereby inhibit circuit completion, and a second position, in which the interrupter permits transmission of the detection signal across the detection module to thereby permit circuit completion and inform the robotic unit of engagement between the end effector and the vehicle door.

12. The end effector of claim 11, wherein the detection module includes:
a detection module housing configured to receive the transmission member; and
a detection module cover connected to the detection module housing, the detection module cover defining a first axial channel configured to receive the interrupter such that the interrupter is movable through the first axial channel during movement between the first position and the second position.

13. The end effector of claim 12, wherein the detection module housing defines:
a first groove configured to receive a feed section of the transmission member;
a second groove configured to receive a return section of the transmission member, the first groove and the second groove being configured such that the feed section of the transmission member and the return section of the transmission member are in communication with each other, whereby the detection signal is transmitted across the detection module; and
a second axial channel extending between the first groove and the second groove, the second axial channel being configured to receive the interrupter such that the interrupter is movable through the second axial channel during repositioning of the interrupter between the first position and the second position.

14. The end effector of claim 13, wherein the first groove and the second groove each defining an ingress and an egress, the first groove and the second groove being non-linear in configuration such that the egresses defined by the first groove and the second groove are oriented in facing relation.

15. The end effector of claim 11, wherein the interrupter includes:
a body portion; and
a flag extending from the body portion in generally orthogonal relation thereto.

16. The end effector of claim 15, wherein the flag extends in generally orthogonal relation to the second axis.

17. A method of detecting engagement between a robotic unit and a vehicle door during manufacture, the method comprising:
inserting an end effector on the robotic unit into a window channel of the vehicle door along a first axis; and
displacing a toggle on the end effector via engagement with the vehicle door to cause corresponding displacement of an interrupter operatively connected to the toggle along a second axis oriented in generally orthogonal relation to the first axis, wherein displacement of the interrupter permits completion of a circuit so as to inform the robotic unit of engagement between the end effector and the vehicle door.

18. The method of claim 17, wherein displacing the toggle includes repositioning a drive shaft operatively connected to the toggle, the interrupter being operatively connected to the drive shaft.

19. The method of claim 17, wherein displacing the toggle includes compressing one or more biasing members in engagement with the toggle.

20. The method of claim 19, wherein displacing the toggle includes pivoting the toggle in relation to a dowel configured for insertion into the window channel, the one or more biasing members being positioned between the toggle and the dowel.
